(19) United States
(12) Patent Application Publication
(10) Pub. No.: US 2008/0107767 A1
(43) Pub. Date: May 8, 2008

(54) Liquid Milk-Substituting Food Concentrate, Methods for the Preparation Thereof and Food Prepared Therewith

(75) Inventor: Ulco Hueting, Amel (BE)

Correspondence Address: HOFFMANN & BARON, LLP, 6900 JERICHO TURNPIKE, SYOSSET, NY, 11791, US

(73) Assignee: Humelco-Lux AG, Weiswampach (LU)

(21) Appl. No.: 10/561,501

(22) PCT Filed: Jun. 17, 2004
(86) PCT No.: PCT/NL04/00430

§ 371 Date: Sep. 10, 2007

(30) Foreign Application Priority Data
Jun. 18, 2003 (NL) 1023689

(51) Int. Cl. A23C 21/02; A23K 1/18; A23L 1/302

(52) U.S. Cl. 426/2; 426/41; 426/583; 426/72

(57) ABSTRACT

The present invention relates to a liquid milk-substituting food concentrate based on milk whey and/or derivatives derived therefrom and to methods for the preparation thereof, which concentrate can inter alia be very suitably used for the preparation of calf milk which has a good storage stability and which can obviate many of the drawbacks of conventional calf milk. In a liquid milk-substituting food concentrate based on milk whey according to the invention, lactose has been converted for more than 25% by conversions comprising at least a lactic acid fermentation. Further, the food concentrate comprises one or more organic acids other than lactic acid which have been added in a ratio of organic acid:lactic acid of 1:30 to 8:1.

The invention relates to a milk-substituting food for animal and human consumption. In particular, the invention relates to a liquid milk-substituting food concentrate on the basis of whey and to methods for its preparation.

The use of by-products from dairy farming as cattle-feed has a long tradition in farming. Skimmed milk and buttermilk, remaining behind in butter-making, were used, for instance, as feed for calves. Whey, remaining behind in cheese-making was fed mainly to pigs after having been skimmed (for the preparation of whey butter). Nowadays, specialized companies make composite feed mixtures which are sold practically exclusively in dried form. As a rule, such animal feeds are composed for a specific group of animals or a specific stage in life (pigs, chickens, calves, etc.). For calves, “calf milk”, a substitute milk, mostly in dried form, is used as feed.

Naturally, calf milk has to meet the requirement that the product is beneficial to the animal, that it is safe insofar that pathogenic bacteria and toxic substances are absent, that it has a high nutritional value, that it is well digestible, that it agrees well (hence causes, for instance, no diarrhea), that it offers good resistance to illnesses, and that it tastes and smells good. This latter is rather essential, as, otherwise, the calves refuse the feed, even when they are starving.

If possible, calf milk should contribute to as many purposes of use as possible. For instance, with feeding calves, especially, a rapid growth is of importance while the feed is to be utilized efficiently. For feeding calves, calf milk must also result in good meat properties, as regards both the taste and the color of the meat. With breeding calves, it is of primary importance that the feed supports the growth of the young animals into healthy cows capable of producing much milk. For breeding calves, calf milk should contain all necessary vitamins and minerals.

One of the most important requirements of calf milk is that, in any case, it has a lower cost price than milk, while having the same nutritional value. That is why milk fat is replaced by other fat and milk components are often replaced by whey components or by vegetable components. In this manner, in calf milk (and, generally, in cow feed) products not deemed suitable for human consumption can be brought to value. In the EU, surplus skimmed milk powder is made available at a low price for use in cattle feed.

Further, calf milk should be easy to handle at the farm. In case of a powder, this has to be easy to transport, dose and, especially, dissolve. This latter means that it is to be easily dispersible in lukewarm or even cold water. The solution or suspension prepared with the powder should be homogenous and remain so, should not foam too much, display no cream formation, settling or butter formation. The solution prepared with the powder should also be thin enough to be easily taken up by the calf, for instance via an artificial teat, and should not clog it. Also, the solution preferably should not cake. However, milk-substituting foods in powder form having all these properties cannot or hardly be prepared.

Finally, calf milk should be durable in the sense that it should hold for a long time. However, an already prepared solution directly suitable for consumption has the disadvantage that, generally, the storage stability at a relatively high temperature is bad due to the growth of undesired microorganisms.

What has been found now is that a liquid milk-substituting food concentrate can be prepared on the basis of milk whey, which concentrate can inter alia be very suitably used for the preparation of calf milk which can be preserved well and which can obviate many of the drawbacks of conventional calf milk.

The present invention provides a liquid milk-substituting food concentrate on the basis of milk whey, in which the lactose initially present in the milk whey has been converted for more than 25% by conversions comprising at least a lactic acid fermentation, and to which one or more organic acids other than lactic acid have been added for providing a ratio of organic acid:lactic acid of 1:30 to 8:1 in this food concentrate.

The present invention further provides a method for the preparation of a liquid milk-substituting food concentrate comprising the provision of milk whey, the conversion of more than 25% of lactose therein by conversions comprising at least one lactic acid fermentation, addition of one or more organic acids other than lactic acid for providing a ratio of organic acid:lactic acid of 1:30 to 8:1 in the milk whey fermentate, and concentrating the milk whey fermentate for providing the food concentrate.

A different aspect of the present invention concerns a milk-substituting food obtained by dilution of the food concentrate according to the present invention with a suitable solvent, preferably water, as well as its use as milk substitute in inter alia calf feed.

The advantage of a liquid milk-substituting food concentrate according to the invention is that the product can simply be diluted at the location where the food will be consumed. Moreover, with calves, the product does not lead to feeding disorders or diarrhea. The presence of various fermentation products, among which functional oligo- and dipeptides having an anti-inflammatory action, and a high proportion of monosaccharides which can be taken up and used well by young animals, ensure that the product has very good feed-technical properties.

A food concentrate according to the invention has a pH<4.8, so that the solubility and hence the availability of the minerals is optimal. Furthermore, due to the low pH, there will be a smaller risk of E. coli-infections and other infections occurring in the small intestine, since these undesired microorganisms cannot survive in the digestive mass, let alone proliferate therein.

Whey is the aqueous part of milk which remains behind after the coagulation or curdling of milk and removal of the curds. Whey can be obtained through coagulation of milk through acid, heat and rennet. Generally speaking, there are two types of whey. The whey formed as by-product of the rennet coagulation of milk in the production of hard, half-hard and soft cheeses like cheddar, Gouda and Swiss cheese is also called sweet whey and has a pH of 5.9-6.6. The whey that is formed as by-product of the acid coagulation of milk in the production of cheeses such as cottage cheese, cream cheese and ricotta cheese as well as in the production of casein and from skimmed milk is called sour whey. This product is formed by precipitation of casein at a pH of approximately 4.6 resulting from the action of lactic acid bacteria on the milk or (as in casein production) as a result of HCL addition. Herein, all types of milk whey and/or derivatives derived therefrom are indicated as milk whey and can be used in the present invention.

The milk whey that can be used in a liquid milk-substituting food concentrate according to the invention can be sour as well as sweet whey. Sour whey has a slightly lower fat content and a higher lactic acid content and, as a rule, a slightly lower purchase price. In principle, whey derived from milk from any type of mammal is suitable for use in a liquid milk-substituting food concentrate according to the present invention, but in general will be derived from cow's milk, sheep's milk, goat's milk, buffalo's milk or yak's milk. The use of goat's milk or sheep's milk is preferred since this milk has a higher protein content than milk of dairy cows.

The composition of the milk whey that is used for the preparation of a food concentrate according to the invention can be adjusted in advance, for instance by mixing with other whey products, water or milk, but preferably contains approximately 60-80% by weight of milk whey, based on the weight of the food concentrate. Derivatives derived from milk whey can be used too. Herein, this is inter alia understood to include concentrated milk whey and desugared whey. Also, different base materials such as, for instance, glucose and/or protein hydrolysates and/or fats of vegetable and/or animal origin, can be added at any moment during the production of the milk-substituting food, or the concentrate thereof, to the milk whey that is used for the preparation of a food concentrate according to the invention or to an intermediate product.

In a food concentrate according to the invention, more than 25%, preferably more than 35% of the lactose initially present in the whey has been converted. This conversion can comprise the hydrolytic conversion to glucose and galactose as well as the fermentative conversion to lactic acid mostly caused by microorganisms. A food concentrate according to this invention comprises, in any case, a conversion which is the result of microbiological fermentation.

It is possible to ferment the whey with the aid of microorganisms for obtaining a product in which at least 5% of the initially present lactose has been converted to lactic acid. However, this fermentation process costs relatively much time. For that reason, preferably, an important part of the lactose is first hydrolyzed to glucose and galactose. Preferably, this hydrolysis takes place by means of enzymatic hydrolysis, strongly preferred is the action of lactase (beta galactosidase) on the lactose present in the milk whey. It will be appreciated that the possibility exists to first carry out a lactic acid fermentation and then to hydrolyze the lactose. However, in this order, the formation of acid during the fermentation will adversely influence the conditions for enzymatic hydrolysis. For that reason, it is preferred that the enzymatic hydrolysis of lactose be carried out before the lactic acid fermentation.

The amount of lactose that is converted through enzymatic hydrolysis of lactose prior to the lactic acid fermentation can comprise between 25 and 99% of the lactose present in the initial product. Preferably, a degree of hydrolysis of 60 to 90%, more preferably a degree of hydrolysis of 65 to 85% is obtained through the hydrolysis referred to.

Carrying out the (enzymatic) hydrolysis of lactose prior to the lactic acid fermentation has an important additional advantage. The hydrolytic conversion of lactose, preferably with the aid of lactase, results inter alia in the formation of glucose, which can be converted to lactic acid through fermentation with lactic acid bacteria. However, compared to lactose fermentation, the fermentation of glucose proceeds much more rapidly. Therefore, this (enzymatic) lactose conversion has the advantage that the time required for lactic acid fermentation can be considerably shortened. The higher production rate which is thus obtained reduces the necessary fermentation and storage capacity because the product needs to remain in the fermentation tanks less long. Therefore, with the production of large quantities of milk substitute, the present method offers an important economic and logistic advantage. In addition, the single sugars galactose and glucose which are obtained through the conversion have a higher nutritional value and, in particular with higher dry matter contents of the food concentrate, crystallization of lactose will occur less readily.

The lactic acid fermentation can be carried out, for instance, with the aid of a starter culture. In principle, a wild fermentation is possible, but not always desirable. As starter cultures, in principle, a large variety of microorganisms can be used. In principle, yeasts and bacteria able to convert lactose, glucose and/or galactose are suitable to be used in the present invention. In particular lactic acid bacteria such as Lactobacillus, Streptococcus, Lactococcus, Pediococcus and Bidifobacterium and yeasts such as Kluyueromyces, Saccharomyces, Candida and Torula are highly suitable. Preferably, the starter culture comprises one or more lactic acid bacteria, More preferably, the starter culture comprises one or more of the bacteria selected from the group consisting of Lactococcus lactis subspecies (ssp.) cremoris, Lactococcus lactis ssp. lactis, Lactococcus lactis ssp. lactis biovar diacetylactis, Leuconostoc mesenteroides ssp. cremoris, Streptococcus thermophilus, Lactobacillus delbrueckii ssp. bulgaricus and Lactobacillus helveticus, as well as the recently discovered Bacillus thermofillus amylovorans.

Depending on the selected lactic acid bacteria, in addition to lactic acid, other acids or metabolic secretion products, proteins and/or flavor components can be present in the food concentrate according to the invention. For instance, heterofermentative lactic acid bacteria can contribute to the formation of, for example, acetaldehyde or acetate. Yeasts and Leuconostoc-species can give rise to, for instance, the formation of ethanol. Such products are not always desirable. By contrast, species such as Lactococcus lactis subsp. lactis can, in turn, produce nisin, thereby providing the end product with a substance having a strong antimicrobial action.

More preferably, in a milk substitute according to the present invention, homofermentative lactic acid bacteria are used. A homofermentative lactic acid bacterium is capable of converting lactose, via glucose, into, substantially, lactic acid, without forming CO₂.

In the selection of the starter cultures, it should be taken into account, in order to obtain the desired end product, that certain microorganisms are mesophilic and others are thermophilic, and that hence, they have different optimal growing temperatures.

The fermented milk whey product, herein also called the fermentate, is evaporated so as to obtain a concentrated product. In the method described hereinbelow, the preparation thereof will be explained further.

The food concentrate according to the present invention comprises a dry matter content of at least 20%, preferably at least 25%, still more preferably at least 40%. An advantage of a high dry matter content is that in this manner, the storage stability of the product improves.

The food concentrate has a pH in the range of 3.0 to 4.8, preferably in the range of 3.8 to 4.5. This low pH is partly the result of the lactic acid fermentation, and partly the result of addition of additional organic acids. Suitable organic acids that can be used in the embodiments of the food concentrate according to the invention comprise both saturated and unsaturated aliphatic monocarboxylic acids (CⁿH_{2n+1.}COOH) among which the aliphatic fatty acids and, also, aromatic fatty acids. Suitable organic acids that are used are, for instance, the free acids of acetic acid, citric acid, formic acid, propionic acid, sorbic acid, tartaric acid, oxalic acid, malic acid, malonic acid, maleic acid, methacrylic acid, fumarate, adipic acid, caprylic acid, dehydroacetic acid, benzoic acid or combinations thereof. Most preferred is the use of formic acid as organic acid. Formic acid has a good solubility, a low pKa, a good preservation value (killing effect on Salmonella bacteria).

Usually, the organic acid is present in an amount which is proportional to the amount of lactic acid present in the fermentate. A suitable ratio is in the range of 1:30 to 8:1. Preferably, the ratio of organic acid:lactic acid is 1:15 to 5:1, and more preferably approximately 1:10.

After fermentation, an amount of approximately 1 to 12% by weight of lactic acid will be present in the fermentate, which amount is based on the dry matter weight of the food concentrate. Preferably, the food concentrate comprises 2-10% by weight, more preferably approximately 3-8% by weight of lactic acid, based on the dry matter weight of the food concentrate.

The thus above-described food concentrate contains proteins, chiefly whey protein, and minerals derived from the whey. A food concentrate according to the invention provides a food with high grade proteins. Customary protein contents in a food concentrate are 15-22% by weight of protein, based on the dry matter weight of the food concentrate, which contents depend on the content and the availability of the amino acids from the various (whey) base materials. If desired, the protein content of the fermentate can be increased by adding proteins from other sources. A concentrate can comprise various further additional nutrients. For instance, a concentrate can comprise further added proteins, amino acids, protein hydrolysates, fats, carbohydrates, sugars, (milk) minerals, vitamins, emulsifiers, anti-oxidants and/or flavorings.

Further added proteins or protein hydrolysates can, for instance, also be entire milk protein, such as, for instance, skimmed milk (powder) and WPC (whey protein concentrate) powders. Preferably, a so-called low-heat type protein powder is used, since highly heated milk can cause diarrhea and feeding disorders in calves. Also, whey protein concentrates and/or vegetable proteins, in particular from, for instance, soy beans, wheat and/or pea gluten, fish and/or meat offal products and combinations thereof can be used. Suitable amounts of added proteins or protein hydrolysates are in the range of 3 to 12 g/L with 5% dry matter. Preferably, the total protein content of the eventual feed concentrate is in the range of 15-22% by weight based on the dry matter weight.

Further added amino acids can be, but are not limited to, for instance, methionine, lysine, threonine, and/or tryptophane. Suitable amounts of added amino acids are in the range of 0.1-0.9% by weight based on dry matter.

In case of a formula for calf milk, further added vegetable and or animal fats can be, for instance, cocoa fat, partially hydrogenated fish oil, bovine fat (often bone fat), lard and vegetable fats such as palm fat and coconut fat. Preferably, the fat is an inexpensive fat giving no off-flavors (for instance through autoxidation). For calf milk, a highly unsaturated fat is, in fact, less suitable, because calves do not tolerate this very well. A fat having very substantially long-chained, saturated fatty acid residues is poorly digestible, possibly since it does not melt entirely at body temperature. A fine distribution of the fat is essential to the digestibility. The skilled person will understand that, depending on the intended consumer of the present milk substitute, the source and the type of fat can be adjusted. Suitable amounts of added fats are in the range of 7-12 g/L with 5% dry matter. Preferably, the total fat content of the eventual food concentrate is in the range of 14-24% by weight based on the dry matter weight.

Further added carbohydrates in a milk-substituting food concentrate can be provided, for instance, in the form of starch. Sometimes, calf milk contains up to 10% by weight of carbohydrate starch which, with a view to digestibility, should be rendered accessible. More starch is undesirable because of the nutritional value (bad digestion) and the viscosity increase which can cause too low a passage speed in the intestine and even constipation. Suitable amounts of added carbohydrates are in the range of 2 to 5 g/L based on 5% dry matter.

As a rule, further added minerals are necessary, as milk whey does not contain sufficient minerals. For instance, calcium and phosphor can be added up to the RDA-standard (recommended daily amount). Calves for feeding should not take up much iron; generally, it is added to calf milk for breeding calves. When rather a lot of whey (powder) is used, it can be partially desalinated, in view of the tolerance of the calves with regard to Na, K and Cl. Suitable amounts of added minerals vary per type of mineral, but when selecting an amount, the skilled person may be guided by the respective RDA-standard. Additions of minerals in the form of a pre-mix are very well applicable. In an alternative embodiment, the content of minerals in a food concentrate according to the invention can be reduced. To this end, a whey used as a starter material can very suitably be stripped of minerals by means of methods known to the skilled person. In conventional calf milk compositions, the total content of minerals is 10% by weight based on dry matter. In a calf milk composition according to the present invention, wherein the solubility and the availability of the minerals is higher, this content can be reduced by 15-20% to 8-8.5% by weight based on dry matter so that, also, a lower mineral emission into the environment (through manure and slurry) is involved in comparison to a conventional calf milk in powder form.

Also, through a so-called desalination of the whey (to 90%), a milk substitute according to the invention can be obtained which is highly suitable for human consumption and which milk substitute comprises a total mineral content of less than 2.5% by weight based on dry matter. The skilled person will understand that, depending on the intended consumer of the present milk substitute, the amount and the combination of minerals can be adjusted.

Further added vitamins can be, for instance, A, D3, E, K and most B-vitamins. Suitable amounts of added vitamins vary per type of vitamin and can be determined on the basis of the recommended daily amounts (RDA).

A suitable anti-oxidant is, for instance, vitamin E which can be added in an amount in the range of 100-250 mg/kg dry matter.

Further added flavorings can, for instance, be added in amounts in the range of 0.05 to 0.3% by weight based on dry matter.

To improve the texture and consistency of the food concentrate and, for instance, improve the dispersion of fat, emulsifiers such as, for instance, soy lecithin and animal gelatin can be included therein.

The skilled person will be capable of adjusting the composition of the food concentrate to the intended use. The use of milk-substituting foods and the different compositions supporting such uses are, for instance, extensively discussed in “Whey and Whey Utilization”, 1990, Sienkiewicz, T. and C. L. Riedel, eds., 2^{nd} Ed. Verlag Th. Mann, Gelsenkirchen-Buer, Germany.

A method for the preparation of a liquid milk-substituting food concentrate according to the invention comprises the step of providing milk whey from any suitable source as described hereinabove. Also combinations of whey, combinations of whey derivatives of different origin and whey-refining processes, or combinations of whey supplemented with other animal or vegetable fat and protein sources are possible, on condition that the eventual concentrate comprises at least 60% of whey components.

In principle, whey should be processed as rapidly as possible after the separation of the other milk components, because the temperature and composition of the whey stimulate growth of bacteria. If desired, prior to the processing of the whey, pasteurization can take place (72° C., 10-15 seconds). Also, optionally, the pH of the whey can be adjusted, for instance to the optimum pH of lactase, and the whey can suitably be prepared to serve as starting material for a desired lactic acid fermentation (for instance by adjusting the aeration or gas-saturation).

A method for the preparation of a liquid milk-substituting food concentrate further comprises the step of converting more than 25% lactose in the milk whey through conversions comprising at least a lactic acid fermentation. As mentioned, for carrying out this step, a combination of hydrolysis and lactic acid fermentation or lactic acid fermentation alone can be used. Preferably, however, the lactic acid fermentation is used in combination with, preferably preceded by, a hydrolysis of lactose.

Preferably, the hydrolysis of lactose comprises an enzymatic hydrolysis, more preferably with the aid of lactase. A suitable lactase is, for instance, Lactozym 3000 lactase (Novozymes, Denmark) which is preferably used in an amount of 20-50 mg/L (0.5-1.25 g/kg of lactose). The hydrolytic conversion with the aid of this lactase preferably takes place at a temperature of 37 to 39° C., for a period of approximately 0.5 to 6 hours. In case the starting point is a sour whey (with a pH of 4.5-4.9), preferably, Fungal lactase is used in an amount of 0.3 g/kg lactose. This form of lactase yields an optimal conversion at a temperature of 50° C. The skilled person will understand that, depending on the lactase used, the reaction conditions and the duration of the reaction can be adjusted. The hydrolysis with the aid of lactase is terminated the moment a degree of hydrolysis of at least 25% is reached. The degree of conversion can be determined with the aid of, for instance, a commercial test, such as, for instance, with the aid of enzymatic lactose test (test kit).

Then, the hydrolyzed whey can be inoculated with a starter culture of lactic acid bacteria. The hydrolyzed milk whey, or, in more general terms, the liquid starting material in case no hydrolysis step is carried out, is then inoculated with starter cultures of lactic acid bacteria. The inoculated starting material is incubated for a few hours at 25 to 40° C. During this period, the bacterial population grows and acid is formed from glucose and/or lactose, so that the pH decreases. The fermentation is carried out for a duration of 8-24 hours at a temperature of 25-40° C. As to temperature, the optimal growing temperature of the microorganisms used is to be taken into account. A suboptimal temperature can also be used, for instance in case certain metabolic secretion products are desired, which are formed at such (lower or higher) temperatures. Depending on the types of microorganisms used and the temperature set, the duration of the fermentation can be shorter or longer. The fermentation is terminated when the desired pH is reached (generally between 4.2 and 4.6) by heating the fermentate at a temperature of 72° C. for 10-20 seconds. Then, the product is cooled to a temperature of 45-65° C.

Thereupon, the fermentate according to the invention is concentrated from a dry matter (dm) content of approximately 5% to a dry matter content of 20-65%, preferably 30-45%. Concentrating whey is a treatment known to the skilled person and can, in practice, be combined with the above-mentioned heating of 72° C. for 10-20 seconds. When concentrating whey, a considerable portion of the water is removed, for instance by means of evaporation. However, evaporation of whey normally leads to crystallization of lactose due to the bad solubility of lactose in a whey concentrate. An advantage provided by the present invention is that the lactose content is reduced through fermentation and preferably additional hydrolysis, such that no crystallization will occur in the fermented whey concentrate.

Prior to or after, but preferably during the concentrating of the fermentate, the optionally present additional components can be added. Hydrolyzed different protein liquids with lower dry matter contents are preferably added during the concentration step for increasing the dry matter content of the food concentrate. Also, for instance, desugared whey can be added.

The fermentate can be concentrated, for instance, by using a falling stream evaporator, while the acidified hydrolyzed fermentate flows as a thin film through tubes which are heated by steam. Eventually, a cyclone provides a good division between evaporated water and the fermented whey concentrate. A concentrate can be of the so-called low-heat or high-heat type. However, low-heat concentrates are preferred because they prevent Maillard reactions between sugars and amino acids. Such types of concentrates can be obtained by means of evaporation in a vacuum but, to this end, reversed osmosis is also very suitable to 25% dry matter.

Prior to, after, but preferably during the concentration of the milk whey fermentate, additional minerals, amino acids fat and/or water soluble vitamins, flavorings, vegetable and/or animal protein hydrolysates, emulsifiers, anti-oxidants, vegetable and/or animal fats, glucose syrup and/or binding agents can be added.

To the concentrated fermentate, an organic acid other than lactic acid is added for providing a ratio of organic acid:lactic acid of 1:30 to 8:1. Preferably, the organic acid is added in a ratio of organic acid:lactic acid 1:15 to 5:1, and more preferably approximately 1:10. Preferably, the addition is done in the form of an aqueous solution of the acid. Optionally, the acid can be added prior to the concentration of the milk whey fermentate, but is preferably added after the concentration thereof, due to the corrosive action of the added acids, and in particular that of formic acid. Preferably, the addition of the organic acid to the food concentrate comprises the last addition step of the method for the preparation of a food concentrate according to the invention.

After adding the acid and, optionally, premixing the vegetable and animal protein hydrolysates with a static mixer and/or a thorax mixer, the concentrate is emulsified, preferably while slowly stirring, and then homogenized, preferably in two steps. Highly suitable is a homogenization wherein, in a first step, homogenization takes place at 300 bar and, in a second step, at 75 bar. Then, the fat distribution can be examined, for instance by microscopically studying a sample of the concentrate.

Optionally, the food concentrate is then pasteurized or sterilized, preferably, however, optionally treated with a FSH (Falling Stream Heating) or an ISI (Innovative Steam Injection) treatment, wherein the product is heated in a continuous system to a temperature of 142-160° C., preferably for <2 seconds, whereupon it is immediately cooled to 65° C. Then, the food concentrate is cooled to a temperature of approximately 15° C. and, optionally, stored at that temperature.

Then, the milk-substituting food concentrate is packaged, preferably in an aseptical or ultra-clean manner (P<1=10,000). Highly suitable packages are, for instance, a 1000 L Multibox, an aluminum bag in a box of 20-400 L or a mobile tank, as desired. Optionally, the packaging can take place under a CO₂/N₂ atmosphere, which positively affects the storage life. The packaged food concentrate can then be delivered to the consumer.

The preparation of a milk-substituting food according to the invention can very suitably take place by means of suspending and/or dissolving the liquid milk-substituting food concentrate according to the invention in, preferably, water. The degree to which the concentrate is diluted depends on the use. The dilution can very suitably be regulated depending on the desired dry matter weight of the milk-substituting food to be prepared. For instance, for rearing breeding calves of an age of 1 to 6 weeks, a dry matter content in the milk substitute of 12-15% is suitable. For slightly older breeding calves, a dry matter content of 8-12% can be desirable. However, for use with calves for feeding, a dry substance content of 15-18% will be preferred, and for calves for feeding of 15 weeks and older, a dosage of even 18-22%. Therefore, the final dosage depends on the desired dry matter content and will, in general, be in the range of 8-22% dry matter. Depending on this dry matter content, the livestock farmer very suitably sets a dosing apparatus in which, for instance, an in-line viscosity measurement can take place, and in which the degree of dilution is automatically adjusted.

A milk-substituting food can, in principle, be used as food for any type of mammal, humans included. Highly suitable is the use as substitute for mother's milk for agricultural domestic animals such as calves, foals, piglets, lambs, goats and sheep, preferably calves. For calves, presenting it ad libitum is highly suitable.

The present invention will now be illustrated in and by the following examples which should not be construed to be limitative.

### EXAMPLES

### Example 1

### Preparation of Concentrated Calf Milk Composition

To liquid sweet whey with a dry matter content of 5%, an amount of 20-50 mg/L Lacotzym 3000 was added. This mixture was kept at a temperature of 37-39° C. in insulated tanks with an excess pressure control. Depending on the dry matter content and the pH this part of the process took 0.5-6 hours before a degree of hydrolysis (conversion of lactose to glucose and galactose) of more than 50% was achieved.

Then, a mixture of lactic acid bacteria (Lab. helveticus, Strep. thermophilus) was added to the hydrolyzed whey. At the moment the desired pH was reached (4.2-4.5 based on 10% dry matter), the fermentate was thickened through a falling stream evaporator to a dry matter content of 20-45%. During this step, the lactic acid bacteria were inactivated in that the fermentate was heated over 72° C. for 10-20 seconds in the preheaters of the evaporator.

Optionally, prior to the evaporation step, hydrolyzed protein liquids can be added in case the concentration is lower than 15% dry matter of the respective protein hydrolysate. Then, to this thickened fermentate with a temperature of 45-60° C. (after having left the evaporator), the following components are added: minerals, amino acids, fat soluble vitamins, water soluble vitamins, vegetable and animal protein hydrolysates, emulsifiers, anti-oxidants, mixture of vegetable and/or animal fats, glucose syrup and binding agents such as pectin and/or flavorings. The mutual ratio of these components is age- and animal-dependent.

Thereupon, 2% of a 10% formic acid dilution on a dry matter base was added while stirring so that a pH of 3.8-4.2 (10% ms) was reached.

After premixing the vegetable and animal protein hydrolysates with a static mixer and/or a thorax mixer, emulsification took place for 15-25 minutes in a collecting tank with slowly revolving mixing gear (2-10 revolutions/min) and the thus obtained mass was homogenized in two steps, in the first step at 300 bar and in the second step at 75 bar. To verify the fat distribution, a sample was microscopically examined. Thereupon, the product was heated by means of FSH heating for 1 second at 148° C. and cooled to 65° C. and then packaged in an aseptical/ultra-clean manner in 200 L containers, optionally at an excess of CO₂/N₂ atmosphere. Then, the product was stored in a cold storage space at 15° C.

Depending on the dry matter content and the base materials used, the thus obtained product had an a_{w} value of <0.75 and a storage life of 8 weeks to 12 months. For determining the storage life, the physical stability of the solution was observed (no occurrence of settling or cream formation) and the composition was microbiologically examined (total plate count (TPC)<100/ml). Herein, the a_{w} value is defined as the ratio of the water vapor pressure above the food at an equilibrium with its surroundings and the water vapor pressure of pure water at the same temperature.

A food concentrate according to the invention with a dry matter content of 20-25% had a storage life of 8 weeks, a dry matter content of 25-40% had a storage life of 4 months, and a dry matter content of more than 40% had a storage life of 12 months.

At the end users, the dry matter content of the milk-substituting product is brought to the desired content by means of a dosing system and is used, as a rule, within 6 weeks after opening of the package.

Processing storage-stable liquid milk-substituting product (calf milk
composition)

| Process step | Whey 5% dm | Remarks | Particularities |
|---|---|---|---|
| Reception whey | pH > 6.0/ | soft/hard cheese whey | Pasteurisation |
| base material | Cow/goat/buffalo | optionally decreamed | 72° C., 10-20 seconds |
| Hydrolysis | Lactozym 3000 | Conversion lactose 50-99% | Duration: 0.5-6 hrs |
| | | | Temp: 37-39° C. |
| Fermentation | Lactic acid bacteria | | Duration: 8-24 hrs |
| | | | Temp: 37-39° C. |
| Fermentation to | 0.5-0.8% lactic | Continuous pH | Formation functional |
| pH 4.2-4.5 | acid | measurement in | dipeptides with |
| | | fermentation tanks | bacteriostatic action |
| Concentration and | From 5% dm to | Reversed osmosis and/or | End temperature 45-65° C. |
| Inactivation | 20-45% dm | evaporation | |
| Additions/ | Minerals-Premix | RDA standard | |
| Standardization | Amino acids | RDA standard | |
| | Water- and fat | RDA standard | |
| | soluble vitamins | | |
| | Flavorings | Acceptation | |
| | Glucose syrup | | |
| | Fat-mix and/or | 14-20% on dm | |
| | Vegetable/Animal | 16-24% protein on dm | |
| | Protein emulsion | emulsion test | |
| Addition | Organic acids | inter alia formic acid | pH 3.8-4.2 |
| Mixing and | 15-25 minutes | Premixing static mixer | 2-10 rev/min |
| emulsifying | | and/or thorax type mixer | Microscopic |
| | | freq. controlled stirring. | examination fat |
| | | | distribution |
| Homogenization | to 300 bars | 2 steps | Step 1 300 bar |
| | | | Step 2 75 bar |
| Heating | FSH | 142-160° C. | Falling Stream |
| | | <2 sec | Heating |
| Filling | Aseptic/ | | |
| | Ultraclean | | |
| Packaging | 20-1000 L | Multibox 1000 L | |
| | | Aluminum bag in box | |
| Storage life | 4 weeks-12 | Depending on dry | Aw value <0.75 |
| in closed package | months | matter content | Laboratory test |
| | | | Microbiological |
| | | | Analysis TPC < 100/ml |

### Example 2

### Preparation of Concentrated Calf Milk Composition

To liquid sour cream cheese whey with a dry matter content of 5% an amount of 0.3 g/kg lactose Fungal lactase was added. This mixture was kept at a temperature of 50° C. in insulated tanks with an excess pressure control. Depending on the dry matter content and the pH (4.5-4.8), this process part took 0.5-6 hours before a degree of hydrolysis (conversion of lactose to glucose and galactose) of over 60% was reached.

Thereupon, a mixture of lactic acid bacteria (Lab. helveticus, Strep. thermophilus) was added to the hydrolyzed sour whey and kept at a temperature of 35-39° C. At the moment the desired pH was reached (4.2-4.4), measured on a composition with a dry matter content of 10%, the fermentate was thickened by means of a falling stream evaporator to a dry matter content of 35-50%. During this step, the lactic acid bacteria were inactivated in that the fermentate was heated over 72° C. for 10-20 seconds during the passage of the preheaters in the evaporator.

Thereupon, to this thickened fermentate with a temperature of 45-60° C. (after having left the evaporator), the following components were added: minerals, amino acids, fat soluble vitamins, water soluble vitamins, flavorings, vegetable and/or animal protein hydrolysates, emulsifiers, anti-oxidants, mixture of vegetable and/or animal fats, glucose syrup and binding agents such as pectin. The mutual ratio of these components is age- and animal-dependent. During this step, 3% of a 20% mixture of propionic acid and citric acid of each 10% based on the dry matter content of the concentrate was added in-line until a pH was reached of 3.8-4.1, measured with a dry matter content of 10%.

After premixing the vegetable and animal protein hydrolysates with a static mixer and/or a thorax mixer, emulsification takes places for 15 minutes in a collecting tank with a slowly revolving mixing gear (2-10 revolutions/min) and the mass was homogenized in two steps (phases), at 300 bar in phase 1 and at 75 bar in phase 2. To verify the fat distribution, a sample was microscopically examined. The homogenization was carried out before the heating under the same conditions as mentioned in Example 1. Thereupon, the product was cooled to 65° C. and thereafter packaged in a aseptic/ultra-clean manner in 200 L containers, optionally at an excess of CO₂/N₂ atmosphere. Thereupon, the product was stored in a cold storage space at 15° C.

Depending on the dry matter content and the base materials used, the thus obtained product had a storage life of 8 weeks to 12 weeks as determined in Example 1 hereinabove. A food concentrate according to the invention with a dry matter content of 35-40% had a storage life of 4 months and a food concentrate according to the invention with a dry matter content of more than 40% had a storage life of 12 months.

At the end users, the dry matter content of the milk-substituting product was brought to the desired content by means of a dosing system.

### Example 3

### Preparation of a Concentrated Calf Milk Composition

To concentrated sour cream cheese whey with a dry matter content of 25%, an amount of 0.3 g/kg lactose Fungal lactase was added. This mixture was kept at a temperature of 50° in insulated tanks with an excess pressure control. Depending on the dry matter content and the pH (4.3-4.4), this process part took 0.5-6 hours before a degree of hydrolysis (conversion of lactose to glucose and galactose) of over 50% was reached.

Then, a mixture of lactic acid bacteria (Lab. helveticus, Strep. thermophilus) was added to the hydrolyzed sour whey and kept at a temperature of 35-39° C. At the moment the desired pH was reached (4.0-4.2 measured on a composition with a dry matter content of 10%), the fermentate was thickened by means of a falling stream evaporator to a dry matter content of 45-50%. During this step, the lactic acid bacteria were inactivated in that the fermentate was heated over 72° C. for 10-20 second by the passage of the preheaters of the evaporator.

Thereupon, to this thickened fermentate with a temperature of 45-60° C. (after having left the evaporator), the following components were added: minerals, amino acids, fat soluble vitamins, water soluble vitamins, flavorings, vegetable and/or animal protein hydrolysates, emulsifiers, anti-oxidants, mixture of vegetable and/or animal fats, glucose syrup and binding agents such as pectin. The mutual ratio of these components is age- and animal-dependent. Thereupon, 4% of a 15% mixture of formic acid, propionic acid and citric acid of, each, 5% based on dry matter was added until a pH was reached of 3.6-3.9, measured on a dry matter content of 10%.

After premixing the vegetable and animal protein hydrolysates with a static mixer and/or a thorax mixer, emulsification took place for 15-25 minutes in a collecting tank with a slowly revolving mixing gear (2-10 rev/min) and the mass was homogenized in two steps (phases), at 300 bar in phase 1 and at 75 bar in phase 2. To verify the fat distribution, a sample was microscopically examined. Thereafter, the product was packaged in 1000 L multi boxes and thereupon stored in a cold storage space at 15° C.

Depending on the dry matter content and the base materials used, the thus obtained product had a storage life of 3 to 6 months as determined in Example 1 hereinabove.

At the end users, the dry matter content of the milk-substituting product is brought to the desired dry matter content by means of a dosing system and is used, as a rule, within 6 weeks.

1. Liquid milk-substituting food concentrate on the basis of milk whey and/or derivatives derived therefrom, wherein the lactose initially present in the whey is converted for more than 25% by conversions comprising at least a lactic acid fermentation, and to which one or more organic acids other than lactic acid have been added for providing a ratio of organic acid:lactic acid of 1:30 to 8:1 in said food concentrate.

2. A food concentrate according to claim 1, wherein said conversions also comprise a hydrolysis of lactose.

3. A food concentrate according to claim 2, wherein said hydrolysis of lactose is the enzymatic hydrolysis with lactase.

4. A food concentrate according to claim 2, wherein said hydrolysis of lactose comprises the conversion of between 25% and 99% of the lactose present in the initial product.

5. A food concentrate according to claim 1, wherein said lactic acid fermentation is carried out with lactic acid bacteria selected from the group consisting of Lactococcus lactis subspecies (ssp.) cremoris, Lactococcus lactis ssp. lactis, Lactococcus lactis ssp. lactis biovar diacetylactis, Leuconostoc mesenteroides ssp. cremoris, Streptococcus thermophilus, Lactobacillus delbrueckii ssp. bulgaricus, Lactobacillus helveticus and Bacillus thermofillus ezmylovorans.

6. A food concentrate according to claim 1 with a dry matter content of at least 20%, preferably at least 25%, more preferably at least 40%.

7. A food concentrate according to claim 1, with a pH in the range of 3.0 to 5.6, preferably in the range of 3.5 to 4.5.

8. A food concentrate according to claim 1, wherein said one or more organic acids are formic acid, citric acid and/or propionic acid.

9. A food concentrate according to claim 8, comprising at most 15% by weight of the said one or more organic acids based on the dry matter weight of the food concentrate.

10. A food concentrate according to claim 1, further comprising additionally added proteins, desugared whey, amino acids, protein hydrolysates, fats, carbohydrates, minerals, vitamins, emulsifiers, anti-oxidants, glucose syrup, binding agents and/or flavorings.

11. A method for the preparation of a liquid milk-substituting food concentrate comprising providing milk whey, converting more than 25% of lactose therein by conversions comprising at least a lactic acid fermentation, concentrating the milk whey fermentate and adding one or more organic acids other than lactic acid for providing a ratio of organic acid:lactic acid of 1:30 to 8:1 in said food concentrate.

12. A method according to claim 11, wherein said conversions also comprise a hydrolysis of lactose.

13. A method according to claim 12, wherein said hydrolysis of lactose is the enzymatic hydrolysis with lactase.

14. A method according to claim 12, wherein said hydrolysis of lactose comprises the conversion of between 25% and 99% of the lactose present in the initial product.

15. A method according to claim 12, wherein said hydrolysis of lactose is carried out prior to said lactic acid fermentation.

16. A method according to claim 11, wherein said lactic acid fermentation is carried out with lactic acid bacteria selected from the group consisting of lactococcus lactis subspecies (ssp.) cremoris, Lactococcus lactis ssp. lactis, Lactococcus lactis ssp. lactis biovar diacetylactis, Leuconostoc mesenteroides ssp. cremoris, Streptococcus thermophilus, Lactobacillus delbrueckii ssp. bulgaricus, Lactobacillus helveticus, and Bacillus thermofillus amylovorans.

17. A method according to claim 11, wherein said one or more organic acids are added for providing a pH in the range of 3.0 to 5.6, preferably in the range of 3.5 to 4.5.

18. A method according to claim 11, wherein said one or more organic acids are formic acid, citric acid and/or propionic acid, preferably in an amount of 0.2-4% by weight based on the dry matter weight of the food concentrate.

19. A method according to claim 11, wherein during and/or directly after the concentration of the milk whey fermentate, additional minerals, amino acids, fat and/or water soluble vitamins, flavorings, vegetable and/or animal protein hydrolysates, emulsifiers, anti-oxidants, vegetable and/or animal fats, glucose syrup and/or binding agents are added.

20. A method according to claim 11, wherein the food concentrate after the addition of one or more organic acids is additionally mixed, emulsified, homogenized and/or sterilized.

21. A storage-stable milk-substituting food concentrate obtainable by means of a method according to claim 11.

22. A milk-substituting food comprising a diluted storage-stable milk-substituting food concentrate according to claim 1.

23. A milk-substituting food according to claim 19, wherein the dry matter content has been reduced to a content of 8-22%.

24. Use of a milk-substituting food according to claim 22 as calf milk.
